(19) United States
(12) Patent Application Publication
(10) Pub. No.: US 2008/0221882 A1
(43) Pub. Date: Sep. 11, 2008

(54) SYSTEM FOR EXCLUDING UNWANTED DATA FROM A VOICE RECORDING

(76) Inventors: DONALD S. BUNDOCK, TORONTO (CA); MICHAEL ASHTON, BRAMPTON (CA)

Correspondence Address: Miltons LLP, 225 Metcalfe Street, Suite 700, Ottawa, ON, K2P 1P9, CA

(21) Appl. No.: 12/043,644

(22) Filed: Mar. 6, 2008

Related U.S. Application Data
(60) Provisional application No. 60/893,328, filed on Mar. 6, 2007.

(51) Int. Cl. G10L 15/26; G10L 15/00; G10L 21/00; G10L 11/00

(52) U.S. Cl. 704/235; 704/246; 704/270; 704/278; 704/E15.001

(57) ABSTRACT

An apparatus and method for the preparation of a censored recording of an audio source according to a procedure whereby no tangible, durable version of the original audio data is created in the course of preparing the censored record. Further, a method is provided for identifying target speech elements in a primary speech text by iteratively using portions of already identified target elements to locate further target elements that contain identical portions. The target speech elements, once identified, are removed from the primary speech text or rendered unintelligible to produce a censored record of the primary speech text. Copies of such censored primary speech text elements may be transmitted and stored with reduced security precautions.

This application claims the benefit of priority of U.S. Provisional Patent Application 60/893,328 which was filed on Mar. 6, 2007.

### FIELD OF THE INVENTION

This invention relates to identifying specific data of previously unknown specific content in a body of background data. As a specific application, the invention addresses a process of automatically censoring data when creating a voice recording. More particularly, it describes a process for substantially removing unwanted utterances from an audio conversation and producing a first fixation or recording which is free of such utterances so as to maintain the confidentiality of personal information included therein.

### BACKGROUND OF THE INVENTION

While this invention relates generally to identifying specific data of previously unknown specific content in a body of background data, it will initially be explained in the context of censoring audio data. A specific case is where an audio recording is to be made from a live audio stream on the basis that no durable record of confidential information associated with such audio source will be created during the specific procedure. A further case is where the audio stream to be analyzed comes from a previously recorded live conversation and a copy of the source audio is created from such previous recording with the confidential information removed.

As a special example, the case will be addressed where a product or service is solicited over a telephone as in the placing of an order. In such circumstances it is often desirable for these verbal transactions to be monitored for evaluation of employee performance or as proof of an authorized transaction. Recordings of this type can be made in an audio format for preservation purposes and to permit the subsequent analysis of such recordings by monitoring personnel in order to evaluate employee performance, customer satisfaction, etc. This performance analysis process is usually carried-out by an over-seeing individual trained to monitor and assess the behaviour of the employees responsible for sales. Such individual may be stationed at a remote location from the employee who is being monitored and does not require access to confidential information.

It is typical over the course of transactions of this type for there to be an exchange of personal information such as credit card numbers, Social Security Numbers, or other equivalent personal information. A problem arises when personal information communicated by a customer is stored in recordings including those used to evaluate employee performance. Some of the information contained in such recordings will have a confidential character. This personal information, although vital to the transaction, if permanently stored in an audio recording as has been done previously can be accessed by other persons, including those engaged in the monitoring of such conversations. This introduces the risk of a breach in the confidentiality of the customer's personal information arising from unauthorized access to such recordings. This problem is expressly recognized in U.S. application Ser. No. 11/181,572 by Lee et al entitled “Selective security masking within recorded speech utilizing speech recognition techniques” and published on Jan. 18, 2007 as US document publication number 20070016419.

An object of this invention is to provide a means by which, in producing an original first recording of the audio data arising from a live audio source, no durable record of targeted confidential information contained in such audio source will be created in the course of such procedure. An additional object of this invention is to provide an improved procedure for identifying passages in a live audio stream or in previously recorded data which are to be excised from the final recorded copy so that the final recorded copy need not be subjected to restricted circulation. Thus, for example, an object of the invention may include enhancing the prospects of effecting the obliteration or masking of confidential data originally present in recorded data such as a recorded transaction.

A past system and method used to automatically alter audio data that may include undesired words or phrases is described by U.S. patent application Ser. No. 10/976,116 filed May 4, 2006 by Microsoft Corporation. The contents of this document are hereby incorporated by reference. This invention addresses a method for processing audio data to automatically detect any undesired speech that may be included therein. In order to carry out this invention, the audio data are compared to a library of preselected undesired speech data. This could include obscenities, profanity or sexually explicit language. Thus it is a premise of this referenced patent application that the full characteristics of the targeted specific words and phrases are known in advance and that those specific words and phrases are omitted without regard to context.

Having identified a target phrase, the method of this invention includes automatically censoring streamed or previously recorded audio data by removing undesired speech that would otherwise be made available to a listener or an audience. Alternatively, a substitute or surrogate sound may be introduced in the place of the deleted phrase.

Due the nature of speech recognition, identification of a sequence of words is never absolutely accurate. Consequently, the more provisions taken to analyze an input audio stream for the identification of target data, the more likely identification can be made correctly.

A distinction may be made between the identification of expressions which are known in advance, in terms of the substantially complete character of such expressions, and identifying expressions which are not precisely known but which may have partially known characteristics.

The Microsoft prior art system operates on the basis of effecting a comparison of groups of words in the input audio data stream with known groupings—N-grams—in order to identify the undesired words and phrases. Shortly stated, this system presumes that it knows what it is looking for.

However, target information to be identified in a data stream may be of a character that, unless considered in context, may be not fully known or ambiguous. An identification number, such as a credit card number fits this condition. Some information may be known about the target information, e.g. that it comprises a fixed length string of numerical digits which may be parsed into sub-strings or portions. But the identity of the target data in terms of the precise identity of the digits is unknown. Additionally a single digit may or may not be part of the data to be protected, for example, the number 9 might be within a credit card number and therefore requiring censoring, but the number 9 might also occur as part of a postal code, the censoring of which may not be desired.

United States Patent application document 20060190263 by Finke, published Aug. 24, 2006 entitled “Audio signal de-identification”, discloses techniques for automatically removing personally identifying information from spoken audio signals and replacing such information with non-personal identifying information. The contents of this document are hereby incorporated by reference. A recorded audio signal is labeled with timestamps to indicate the temporal positions of all of the speech portions in the recording. Then content considered to constitute personal information is identified and, using timestamp referencing, a duplicate recording is made omitting the personal information. Such content may include according to this reference: name, gender, birth date, address, phone number, diagnosis, drug prescription, and social security number. A feature of all of this type of information is that some knowledge of the nature of such target information may be known in advance, although the exact final character of the target information may not be known. For example, name lists of the most frequent first and last names may stand-in for missing patient name information in order to identify passages intended for “de-identification”.

U.S. patent application Ser. No. 10/923,517 by Fritsch, published document 2006 0041428 published Feb. 23, 2006 entitled “Automated extraction of semantic content and generation of a structured document from speech”, discloses a system by which components of a spoken audio stream are recognized corresponding to a concept that is expected to appear in the spoken audio stream. The contents of this document are hereby incorporated by reference. This invention addresses an automatic process for converting and editing an audio script into a structured text wherein the specific classes of data are at least partially reformatted to follow a template.

United States published application document number 20060089857 to Zimmerman at al, published Apr. 27, 2006 and entitled “Transcription Data Security” describes the use of trigger words or phrases to indicate the boundary of specific portions of a text being transcribed. The contents of this document are hereby incorporated by reference. Examples of trigger phrases include: “The patient is a”, followed by an age; “The patient comes in today complaining of . . . ” According to this reference, these phrases may be supplemented by a statistical trigger model to help identify the boundaries of targeted text. A statistical trigger model can be used alone, or can be combined with a duration model, such as a specified number of words, for the header, body, and footer in order to resolve ambiguities in determining whether particular grammar is a part of the target text. For example, a statistical analysis may include that the phrase “Please send a copy to . . . ” has a 90% probability of being a boundary phrase when it occurs within the final thirty words of a dictation. Accordingly, this reference recognizes the need for redundancy in text identification procedures in order to increase the probability of identifying target information for special treatment.

A further reference already mentioned above is United States application by Lee et al entitled “Selective security masking within recorded speech utilizing speech recognition techniques” and published on Jan. 18, 2007 as US document 20070016419. The contents of this document are hereby incorporated by reference. According to this document, recognized speech data (in a textual recognized format) is fed into an identification process to identify instances of special information uttered and captured in the voice recording. A list of words that are considered to signify requests for special information are established by a user, referred to as a “prompt list”. A prompt list can include an “account number,” and a “personal identification number” or “PIN”.

According to this reference a portion of a voice recording of predetermined duration following a prompt can be identified as an estimate of the location of an occurrence of special information. Utterances of different types of special information can be assumed to last for particular periods of time. In this way, prior knowledge of the estimated likely duration of an utterance can be used to identify the portion of the voice recording that corresponds to an utterance of special information. Identified target information is then either deleted or modified to render it non-disclosing of its confidential character.

Identification can proceed by comparing an expected value with a presented value. For example, a prompt for a “social security number” should result in an utterance that has nine digits or at least digits in the portion of the voice recording following the prompt. If the voice recording following the prompt for the “social security number” is followed by digits then such recording is assigned a high confidence that the utterance contains special information. Conversely, if the processing results in an identification of letters, then a low confidence is assigned. Scores for prospective text identified by the prompt list and the direct evaluation of the prospective utterance of special information are combined and a result above a certain threshold results in an identification of an utterance of special information for purposes of further processing.

Alternatively, identification can simply correspond with a portion of a voice recording following an identified prompt. For example, following a prompt for a credit card number, the next ten seconds of the voice recording can be assumed to be an utterance of special information in response to the prompt. In another example, following a prompt for a Social Security number, the next fifteen seconds of the voice recording can be assumed to be the location of the utterance of special information. Thus, in various embodiments, the special information can be identified using specific speech recognition algorithms or by estimating an appropriate amount of time necessary for an utterance of special information following a prompt for the item of special information.

This reference acknowledges that it is not always necessary to delete or mask all numbers uttered by a person which could be, for example, the numbers of a credit card account. A partial modification of only some of the numbers of a credit card number can constructively conceal the target information to be censored. Thus this reference acknowledges that the proposed procedures for identifying and suppressing target information need not be necessarily fully exhaustive. An opportunity, however, exists for increasing the reliability of identifying target information.

It is true that complete removal from the final recording of all the data is not necessary to accomplish the object of rendering such data secure. For example, the removal of as few as 4 of the 16 digits of a credit card render the remaining numbers worthless to ordinary individuals not equipped with high level computing facilities. The removal of 4 numbers out of 16 means that the remaining numbers represent one instance in 10 exp7 possible numbers. Of all the available numbers inherent in a 16 digit decimal string, only one in 250,000 numbers are used as an active credit card number.

Nevertheless, portions of a number are likely to occur several times in the case of monitored dialogues as an agent may repeat a number being stated by the customer, and the customer may further repeat the number or parts thereof again. Since fragments of a credit card number could appear at different locations within an audio record, it may still be possible for a third-party to reconstruct a credit card number using such multiple sources. Accordingly, it is highly desirable to remove every instance in an audio record where portions of a credit card number may have been uttered.

While all of these references address the same problem which is used to exemplify the present invention, these references generally premise the preparation of the recording of a voice source which is then treated to prepare a censored version of that voice source in a second recorded format. This original recording contains all of this information, either in analog or digital format, present in the original audio source. The very existence of an initial recorded version of an audio transaction gives rise to security concerns. A further proliferation of recorded versions of the audio transaction including sensitive data should preferably be avoided.

It would be desirable to provide a system wherein no durable or persistent version of the original audio data used to create the censored recording or fixation is created as part of the censoring process. Durable or persistent versions of audio data include all types of fixations of such information such as tape recordings, compact discs, flash memory and generally all forms of non-volatile memory which do not require a maintained power supply to preserve the memory. This is to be contrasted with volatile storage as in a computer memory that requires power to maintain the stored data. When power is not supplied, such as when the computer shuts down or reboots, the stored data contained in this volatile storage is erased. The present invention addresses this issue.

Additionally, each of the above prior art references use a method that relies on the awareness of specific words that are to be blocked or that are used to indicate that sensitive data to be blocked immediately follows the specific words. It would be desirable to provide a system that identifies and censors the sensitive data in cases where such data is not necessarily preceded by indicator words. This present invention addresses this issue.

The invention in its general form will first be described, and then its implementation in terms of specific embodiments will be detailed with reference to the drawings following hereafter. These embodiments are intended to demonstrate the principle of the invention, and the manner of its implementation. The invention in its broadest sense and more specific forms will then be further described, and defined, in each of the individual claims which conclude this Specification.

### SUMMARY OF THE INVENTION

According to one aspect, the present invention addresses an apparatus and method for the preparation of a censored recording of target audio data originating from a voice source audio stream whereby no persistent or durable version of the original target audio data is created in the course of producing the censored recording. Target audio data includes fragments of relevant data or information.

According to another aspect, the present invention addresses an apparatus and method for the preparation of a censored recording of audio data originating from either a live audio stream or a recording which is the source of an audio stream by improved identification techniques.

According to the real time variant editing procedure, an audio stream is delivered to a computerized processor which places the audio stream in a first audio version volatile memory for temporary storage, typically and preferably as digitized audio data. The audio data is then run through a keyword/number or voice-recognition procedure using known software to produce a resulting “text” version of the audio source, or to produce a partial “text” version wherein specific words have been identified. Such specific words can include numbers and pauses. For purposes of this description “words” include spoken words and numerals represented by words, i.e. the numeral “8” is transcribed as the “word” “eight”. Pauses are identified as such, herein. This resulting text in either case is stored in a further volatile memory location along with data identifying the location of such identified content in a manner corresponding to the original audio data which is still being maintained in the first volatile memory. This text, and the pattern of pauses within the text, is then treated by the procedures of the invention to identify target information.

In order to produce a final audio recording which has been censored, corresponding markers, e.g. “timestamps”, are embedded in the text data that correspond to the location of the corresponding audio passage in the audio data saved in the first volatile memory and corresponding to the original audio stream. In writing either the audio version of the original audio source, or the text version to a permanent memory such as a disk, the identified target data is censored using such markers. After the desired censored recording has been made, the original audio data or corresponding text information are deleted from the volatile memories wherein they are stored. Throughout the process according to one preferred embodiment, no persistent, durable version of the original audio source used to provide the audio stream is created, nor does such a durable version of such original audio stream exist upon final production of the censored record by reason of such process. At the same time, the final recorded audio data is scrubbed of target data. According to this aspect of the invention, in either case the audio source may either be a live stream or may be an audio stream originating from a prior recording.

According to a further feature, the present invention also addresses a more general system for more precisely identifying target data in a data stream where the full character of such target data is not initially known. According to this further aspect of the invention, the audio source may again be either a live stream or an audio stream originating from a prior recording.

As aids to the identification of target data, reference may be made to two types of data. The first is data having characteristics which are expected to be found in target data. This could include the fact that the data is a number or the presence of a pattern of pauses in data that will be present in the target data. For example, and without limitation, the presence of one or more pauses within or adjacent to one or more numbers could constitute as an identifier for candidate target data. The second type of data which can serve to identify target information is data in a stream of information that is expected to surround, the approximate to or be otherwise associated with the target data. These two classes of data can be both characterized as “context”, the first being “internal context” and the second being “external context”.

According to the present invention in one aspect, speech data (e.g. words and phrases, or corresponding phonemes from an original audio source processed into an analyzable format) which possibly contains target data are analyzed based upon initial, coarse identifiers that are known internal characteristics of the target data e.g. a string of numbers known to form part of a credit card number or the pattern of pauses that exist between numbers that indicate that a particular type of numeric data is present. Such candidate target data, once identified, is then used for further processing.

The present invention differs from the prior art in that, in one aspect, it is able to distinguish credit card numbers from other non-confidential numbers, such as a postal code, by examining for internal characteristics, for example and preferably, the pattern of pauses between words in the case where the words are representations of numbers. When potentially sensitive data (candidate target data) is discovered in the data being analyzed, further searching of data proximate to the location of candidate target data may be effected with the object of locating further candidate target data.

Thus, for example and without limitation, if a pause is identified as present adjacent or proximate to a number, the existence of further numbers on either or both sides of the pause can be used to indicate that the numbers probably constitute candidate target data. Or a pause adjacent to or following a string of four numbers, or a string of four words of which three words or numbers, may be used to characterize such numbers or string as candidate target data. Herein throughout, “candidate target data” includes fragments of target information.

Candidate target data can, based on such analysis of internal context, the excepted as constituting actual target data for the purposes of producing a censored final recording. Such a decision will be based upon the relative probabilities of a false positive or false-negative error occurring.

The candidate target data may also be analyzed for verification to increase the likelihood that target information has been located based on external marker elements believed to be typically associated with target information. This can include external validation terms that aid in the validation of the candidate target data. For example, relevant external context to candidate target data suspected of being, for example, a credit card number may include the names of known type of credit card types, e.g. “Visa”, “Mastercard” etc, or a following expression such as “expiry date”, or following numbers parsed in the format of an expiry date. Alternately or additionally, external marker elements may include a “validation words” that include words spoken by a participant in the conversation who is querying a speaker, such as “account number,” “personal identification number” or “PIN.”

However, there still may remain uncertainty as to whether all instances of target information, such as the balance of a credit card number in the audio data for which only fragments have been located, remains unidentified in the text. To reduce this uncertainty, the searching of the audio data may be further extended.

Using such internal characteristics and external validation elements, candidate target data already established as likely constituting and henceforth to be treated as target data, such established target data may be used for a further comparison with the text version of the audio data. For this purpose, target data that has already been identified is then stored within the computer processing system in a memory designated for dynamic word strings to be used in further searching of the audio text. These word strings are “dynamic” because they arise out of the specific audio stream or text that is being analyzed.

Upon the identification of information believe to constitute target information with sufficient certainty to be classified as dynamic word strings or data, the search can be extended to identify such information elsewhere in the subject text even in the absence of previously applied evaluations of internal or external context. Thus a Visa number, or a portion of such a number, might be recited elsewhere by a participant in a conversation without using an external identifier such as “Visa”. Failure to delete such other instances of confidential information represents a failure of the objective of rendering the overall data set free of target confidential information.

Thus, having identified one instance of target data, which includes fragments of target data, an audio text can be screened again for other occurrences of such target data, or portions thereof. This screening is carried out using the list of “dynamic” word strings target data that have been generated. Such dynamic target elements are derived from the instances of target data already identified from carrying out the initial analysis. The analysis is then repeated using the dynamic target elements. This procedure may optionally be repeated iteratively as further candidate target data is located and characterized as likely constituting confidential target information. In this way the system learns in the process, thereby identifying those instances of target information that may exist in the absence of any identifiable internal or external markers.

In the referenced example of a Visa number, a portion of such identified information taken from one identification may be used to locate other instances where similar target data is present in the data being screened. Further, multiple sub-portions of established target data may also be utilized in this manner. The location of further instances of data that match such sub-portions can be taken as further instances of target information. In each case where a match is found, the newly found data may be treated as further candidate target data and such candidate target data as well as adjacent data may be analyzed based on either or both internal and external context to determine if the candidate target data constitutes a portion of actual target data and therefore is to be added to the list of dynamic word strings.

Where only a portion of target information has been initially identified, the above procedure can be used to identify missing pieces of information based on the identification of such further instances of matching information. The process can be carried out repeatedly in order to identify as many instances of the presence of target information as are present in the data that is being screened. In this manner, the prospect that a data set has been purged of all target information contained therein is increased. And then all such instances of identified target data can be censored.

Using the corresponding timestamps on the audio text, the stored version of the original audio source, in either audio or text form, is then fed to a recording medium through a filter which ensures that the audio or text equivalent of the target information is not included in the recording in an identifiable form. It is not essential to delete such information in its entirety in order to render confidential information unusable. It is sufficient to corrupt the information to the point that it is not usable.

As a further feature of the invention, numbers and credit card numbers in particular can be identified as candidate target data and confirmed as target data based upon the presence of pauses within the audio text. Vocal communications of number strings invariably contains pauses in traditional places. For example, when giving a telephone number in North America, the normal speech pattern when saying (416) 693-5426 is; Four-one-six [pause] Six-nine-three, [PAUSE] five-four-two-six. Similarly, credit card information is in most cases communicated as blocks of 4 digits with pauses between each block. An exception is an American Express card number which may have portions of the number spoken as either of two number formats: e.g. 4-6-5 or 4-3-3-5. Other predictable patterns related to pauses exist in other types of potential target data.

Once pauses have been located in the audio text, an examination of the adjacent text may be carried out to determine if numbers are proximately located with respect to a pause. If four numbers precede a pause, this can be taken as a fairly high level of certainty that this number is part of a credit card number. If three out of four preceding words are numbers, this can also be taken as an indication that candidate target data has been located. This can be confirmed if the pause is followed by another word string wherein three out of four words are numbers. On this basis a string of numbers having known characteristics relating to their standard parsing by pauses in speech can be identified at according to this feature of internal context.

It has been observed above that a word string wherein three out of four words are numbers may qualify as candidate target data. This policy is useful because audio to text engines are not perfect. Certain spoken words intended to represent numerals may not be identified as such. Accordingly, when searching for a string of numbers in a group of words, it may be unnecessarily restrictive to stipulate that every word in the group must be identified as a number. The word preceding a policy need not be a number. Instead, the software can allow an exception, in the nature of allowing for the presence of one or more “wildcard”, whereby a group can be treated as a group of numbers even though less than all members of the group have been identified as numbers. Based on this procedure, a wildcard can be permitted at any location within the group, and where appropriate, more than one wildcard can be permitted.

Again, once target data has been identified using this entry point analysis based upon pauses, such target data may then be used as dynamic word strings to carry out the iterative re-examination of the audio data for further instances of target data based upon such dynamic word strings.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

FIG. 1 is a schematic depiction of the recording of an audio dialogue.

FIG. 2 is a Word Scrubber process flow chart.

### DESCRIPTION OF THE PREFERRED EMBODIMENT

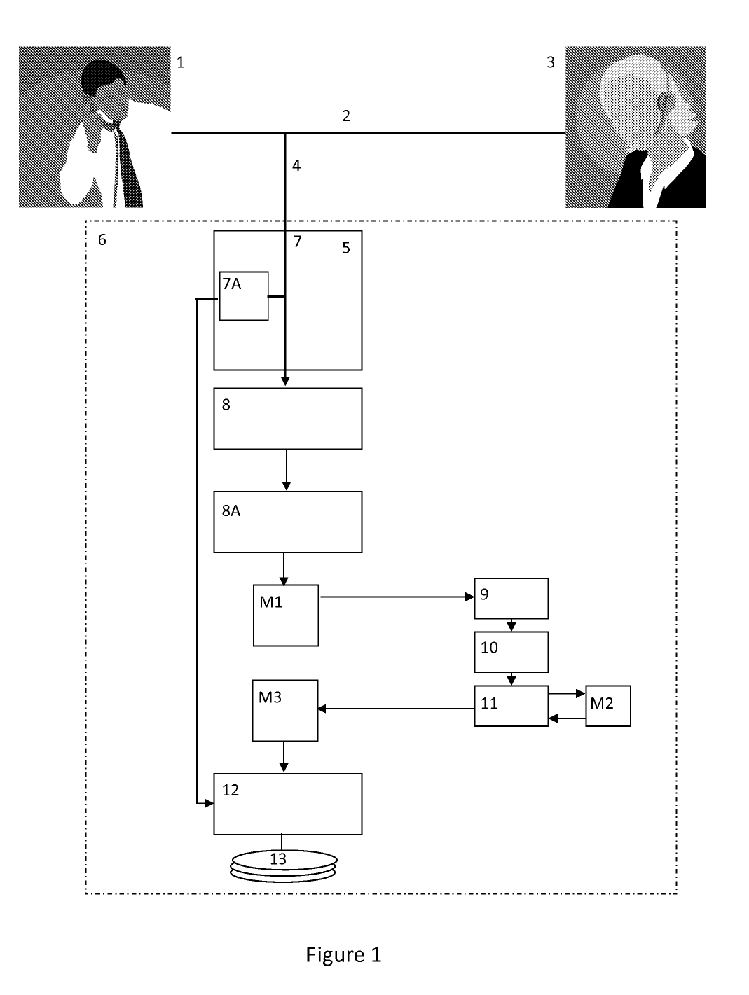

In FIG. 1, a customer 1 speaks over a telephone link 2 to an agent 3. The audio from this conversation is intercepted and fed through a link 4 to an initial storage portion 5 of a computer 6 where the audio version data 7 from the audio stream from the audio source is stored in a first, volatile, audio version random memory 7A in audio format.

Generally, source audio will arrive in either analog or digitized audio format. If the audio data from the source is in analog format, it may be subsequently converted into digitized audio format if this is required by the speech to text engine. Audio data in digitized audio format is information only in the most abstract sense. It is not data that has been coded in a typical machine-readable format. It is data which is suitable for the direct regeneration of speech. For the purposes of the present invention such digitized audio information must be converted into the data in a machine-readable format.

This audio data 7 is then fed through an audio to text converter 8A of which there are several existing, known types, including Dragon Naturally Speaking™ and Sphinx™. This latter tool was produced by Carnegie Mellon University for the National Security Agency. The audio to text conversion engine is used to produce an audio text 8 which is then stored in a second, volatile random audio text memory M1. Each identified word in the audio text 8 receives a timestamp that corresponds to the point in time the word was uttered in the audio stream as now stored in the first, volatile, random memory 7A. Such identified words can include numbers and pauses. Alternately, the text converter can operate to identify numbers or numbers and pauses, and a limited number of validation only, thus speeding up the analysis of the audio stream.

Using the numbers as an example, the numbers in the audio text 8 are loaded into the volatile memory audio text array M1 as having been identified as candidate target data. Such data is then passed through multiple layers of processing 9, 10, 11 with tests and rules applied that examine the internal and external context associated with such numbers. In particular, the pattern of the pauses or silence intervals between the numbers, the proximity of the number to other numbers, and the relationship of the identified number sequences to other, non-numeric words in close proximity to the number sequences, may be examined to determine if any of the sequences of numeric characters exhibit the characteristics of the type of numeric sequences that qualify as target data which should not be recorded in the final recording that is to be made.

If a sequence of numbers in the audio text memory array M1 is found to constitute target information, then such target data is labeled and saved in the labeled audio text memory array M3 as such, along with its delimiting timestamps. The corresponding timestamp for that sensitive data is passed to the Audio Edit Engine 12 to be used to omit the recording of that specific segment of the live audio stream when the final recording 13 is prepared.

As sequences of numbers to be omitted from the recording are identified as target data through multiple layers of processing 9, 10, 11 with tests and rules applied, short selected segments of the numbers in those sequences are stored in another memory array M2 for use as dynamic word strings. Such dynamic word strings are then used to identify other occurrences of the short number segments present anywhere else in the data stored in the audio text memory array M1. If a segment of numbers from memory array M2 is found in memory array M1, the delimiting timestamps for those numbers is stored in the labeled audio text memory array M3 as a log of sections of the live audio stream to be omitted from the recording to be sent to the Audio Edit Engine 12.

Once all the blocks of numbers that should not be recorded are identified and the timestamps and duration for those segments have been sent to the Audio Edit Engine 12, the Audio Edit Engine 12 then controls a filter editor during the transfers of the audio data 7 from the first, volatile, audio version random memory 7A to a recording medium 13. This ensures that the audio equivalent of the target information is not included in the recording 13.

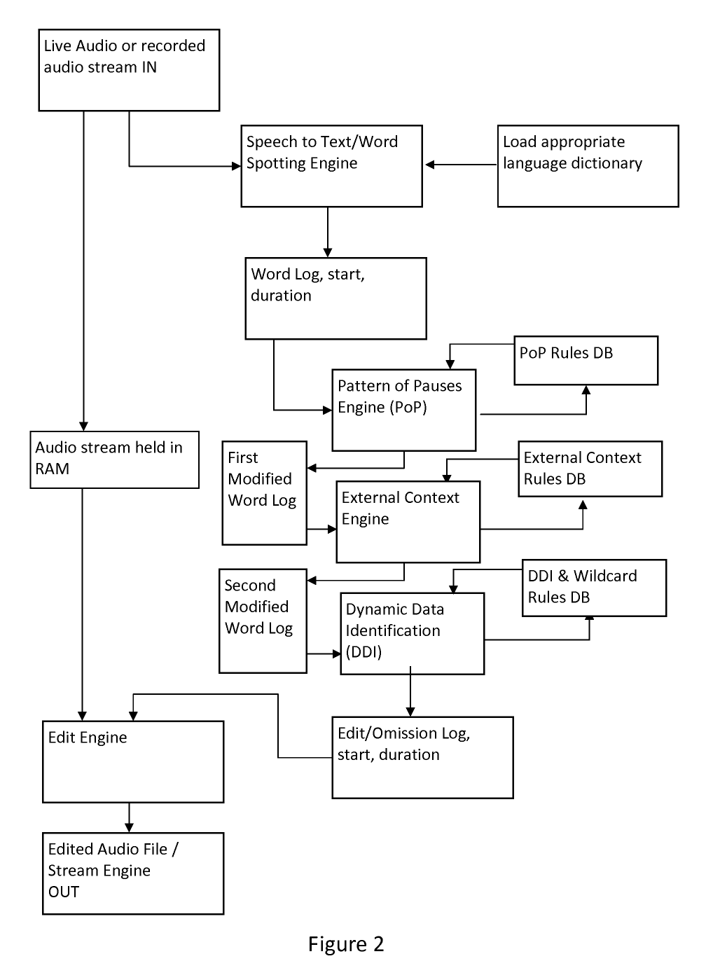

According to another version, the process flow chart in FIG. 2 has the following components:

Audio File or Stream IN: there are two methods to produce a processed or clean audio file:

1—Live mode: the system will process the audio stream and record an original copy of the audio stream with all the targeted data omitted.
2—Batch mode: the system will create a copy of an original, earlier recording with all the targeted information omitted.

Speech to Text Engine: this is a computer program that converts a speech file to a text file. The program will take input as a Live Audio Stream or an Audio file. The program will detect the first few words spoken in the conversation and determine which language is spoken. The program then will call the Load Appropriate Language Dictionary process.

It is important, in the audio transcript application, to use an audio-to-digital engine of sufficient power to provide accurate digital data that corresponds reliably to the spoken words of the audio text. Successful deletion of target information is less likely to occur when the digital data set is corrupted from what was really said by the parties verbally. It is a challenge for a speech-to-text engine to distinguish between “far,” and “four” particularly when the speaker has an accent. It is a question of probability. Redundancy is the antidote to uncertainty. If uncertainty is high, then redundant procedures may be needed to increase the probability of a successful outcome. A successful outcome means the deletion of target information with a high degree of reliability. A highly accurate audio-to-digital engine can remove one source of uncertainty. This places reduced demand for the presence of redundancy in the processing protocol.

A preferred digital to audio engine is known as Sphinx™. This tool was produced by Carnegie Mellon University for the NSA. It operates on a higher bit rate analysis of the audio text and not the standard eight-kilohertz bit rate.

Load Appropriate Language Dictionary: a process that is called by the Speech to Text Engine to load the right dictionary file. For example: After detecting a few words said at the beginning of the conversation, the Speech to Text Engine decides that the language spoken is French, it will call the Load Appropriate Language Dictionary process to load the French Dictionary. The Dictionary is a text file with a special format that defines the text format and speaking rule of a word.

### Word Log, Word, Start, Duration:

1) Word Log: text file produced by the Speech To Text Engine and stored in the Memory Array in the form of a list of words present, together with their associated locations. Not all words need be identified or listed. The Word Log may simply contain numbers and validation words in the form of external markers associated with target data. The audio data is time stamped as it is stored. This means that it is labeled so that every element of data in the set has a specific location address associated with such element.

2) Words: in the Word log. The format of words in the Word log is: xxx (start-time, end-time). For example: Seven (120:30, 121:12)—e.g. the word “seven” is said starting at the 120.5^{th} second, and ended at the 121.2^{th} second.

3) Start: start-time of a word

4) Duration: The time between the beginning of the word and the beginning of the next word or the beginning of a silence period. The length of time anticipated between the end of a word and the detected beginning of the next word is a user controllable function that is used to define deemed silence spaces.

The Context Rule Engine: is provided with a list of Internal Context Rules and Validation Words which it is to apply based upon the content of the Word Log. An action list for amending the audio data is produced by the Context Rule Engine, derived by analyzing the content of the Word Log, to provide an Edit Log.

Rule Database: is a series of rules used to identify the characteristics of the specific type of target data to be omitted. The Rules to be applied may either be static or dynamic. Static rules are rules that are permanently maintained for general application. Dynamic rules are new, temporary rules that may be created based upon the contents of a specific Word Log generated from a specific audio script, or from circumstances surrounding such script, such as knowledge as to the language being spoken. Generally, dynamic rules are created only for use during the analysis of the Word Log arising out of a specific audio script. Static rules may be modified from time to time but are in place at the beginning of the analysis of a specific audio script-based Word Log.

Dynamic rules may invoke a routine by which the speech-to-text engine is asked to re-analyze the audio script, based upon additional temporary target terms generated by the Context Rule Engine.

Edit Log/Start/Duration/Action: this is the list of instructions which controls all parameters for the Audio Editing process. It determines when (start), how long (duration) and how (action) an editing process is to be done.

Audio Edit Engine: in this process, the Audio File or Audio Stream will be processed based on the parameters passed by the Edit Log process. For example: At time-stamp 121:12:10 prohibit recording for 2.8 seconds.

### Internal and External Context Test Types

There are three types of tests for internal context that may be conducted on the text representation of the audio files held in Memory Array (M1). Examples of the types of numeric data that can be identified are; credit card numbers, telephone numbers, Social Security Numbers, Social Insurance Numbers and specialty numbers such as membership or account numbers. Each type of test is conducted using rules that are created to identify a specific type of sensitive data. Each test is applied consecutively to the blocks of text stored in the Memory Array (M1). If the result of a test is conclusive that target data has been identified, then no additional tests are applied. If a test result is inconclusive, then additional tests are applied until a conclusive result is obtained. Such tests include:

1) Internal Pattern of Pauses—POP Test: Vocal communication of number strings invariably contains pauses in traditional places, for example, when giving a telephone number, the normal speech pattern when saying (416) 693-5426 is; Four-one-six [pause] Six-nine-three, [PAUSE] five-four-two-six. The pattern of pauses; three digits, pause, three digits, pause, four digits, is unique to a North American telephone number. A speaker would not give their telephone number as Four-one, [PAUSE] Six-six-nine, [PAUSE] Three-five-four-two six. Similarly, credit card information is virtually always communicated as 4 blocks of 4 digits with pauses between each block. (An exception is an American Express card number which is spoken as either of two number formats 4-6-5 or 4-3-3-5). Other predictable patterns exist in other types of potential target data. Is it a function of the Rules that are applied within the Pattern of Pauses Test to determine whether or not the data is a candidate for omission from the recording. Rules can be added to identify any type of pattern recognizable speech.

2) External Context Test: Once the Pattern of Pauses Test identifies data that may be a candidate for omission, the External Context Test is applied to the text immediately prior to or following the numeric block, looking for a limited number of words that would provide confirmation of the nature of the numeric block. For example, if the Pattern of Pauses Test identified a number sequence that was possibly part of a credit card, text immediately prior to the candidate series would be examined looking for words such as “VISA” “MASTERCARD”, “CREDIT CARD” etc. The words that pertain to each type of sensitive data are held in the “Validation Word” database as pre-established markers. The existence of these “Validation Words” is used to determine conclusively the nature of the text block as being target data.

3) Post-Words rule: In the previous example a Validation Word was presumed to precede information that is a candidate to be treated as target information. Validation words following the candidate information can also be used. In the example of a credit card, in an exchange between a client and an agent, after the customer gives the credit card number, the agent generally asks for the expiry date of the card. The expression “expiry date”, or “expiry”, can be used as a post-validation word.

Validation words may be in the form of a variety of validation terms including:
1) the name of a known type of credit card such as Visa, MasterCard, American Express, AMEX, Discover, Diners Club, JBL, Bankcard, Maestro, Solo,
2) the word “expiry” as a following expression,
3) the word “date” as a following word such as “expiry date”,
4) the word “account”,
5) the words “personal identification”,
6) the word “PIN”
7) the word “Card”
8) the word “Number”
9) the word “Account”
10) the word “Member”
11) the word “Telephone”
12) the word “Phone”

If such a Validation Word is confirmed as found in the text of the audio script following the candidate target data, then, for example, some or all of the following rules may be applied:
a. The time stamp for each of the digits in the identified numeric string are passed to the Audio Edit Engine
b. The time stamp and duration of the length of the identified numeric string are passed to the Audio Edit Engine.

Additionally short segments of the identified Target Data may be passed to the Dynamic Data Identification memory to be used during the iterative search process for subsequent or previous occurrences of the short segments.

### Rules to Remove Target Words/Digits in a Speech File

Generally, the rules to be applied will remove all digits/words that are belonged to one of the following items: credit card, phone number, social insurance number or social security number, or all numbers that are targets of identity theft. Depending on the specific item, there are different rules applied.

### Rules to Remove Digits

### Examples Rule(s) for Phone Number

For North American telephone numbers, the Pattern of Pauses Test for digits is, with non-numeric text before and after the block of text being examined and with a pause or silence between the 3rd and 4th digit and again between the 7th and 8th digit with no pauses between the following 4 digits. If this test is positive the External Context Text will be applied and the rule is that the words “Phone” or “Telephone” must exist in the preceding n seconds of speech. Similar specific rules can be maintained in the rules database to identify other types of telephone numbers.

Clear identification of a telephone number on this basis can then be used to either censor the telephone number, if that is the object, or to overrule an indication to censor such number that might be provided by other tests, if the object is to preserve telephone numbers in the audio record.

### Example Rule(s) for Credit Card

1) For North American credit card numbers, the Pattern of Pauses Test for with non-numeric text before and after the block of text and with a pause or silence between the 4th and 5th digit and again between the 8th and 9th digit, and optionally again between the 12^{th} and 13^{th} digit if a full string of digits is provided. If this test is positive for, say, eight digits, then the External Context Test will be applied, the rule being that one of the words “Visa”, “MasterCard”, “Credit Card”, “Discover” or “Card” must exist in the preceding n seconds of speech. Similar specific rules can be maintained in the rules database to identify other types of numbers.

2) Variables such as the start and duration of the section to be searched prior to the candidate target data are part of the rule structure. For example, other rules can be created to provide for Pattern of Pause matching for various types of credit cards (American Express for example would be: 4 digits [pause] 6 digits [pause] 5 digits; or 4 digits [pause] 3 digits [pause] 3 digits [pause] 5 digits. Digits which constitute a fragment of such a string of digits and pauses can be treated as candidate target data.

Rules can be added and refined as needed to identify any type of verbally transmitted numeric data.

Wildcard Rules: approximately 2 out of 100 times a number will not be recognized by a number identification engine and will be replaced in the text version of the audio stream with a special marker. Unrecognized characters are marked as [UNK] (unknown) the Wildcard rules according to the present invention operates to ensure that the occasional [UNK] does not interfere with the Pattern of Pause matching procedure. The Wildcard rule is that: Numeric strings which would have resulted in a positive result, but for the existence of a single [UNK] reference are treated the same was as they would be if the [UNK] was rendered and a known numeric character. Hence, this is referenced as a “Wildcard” rule.

### Dynamic Data Identification—DDI

If the word scrubbing process identifies the utterance of a series of numbers that it identifies as part of target data such as a credit card number, then short segments of that identified sequence can be used dynamically to search the entire text file for prior or subsequent occurrences. The already identified sequence of numbers which are accepted as constituting target data or portions of target data may be broken down or parsed into small segments e.g. 3 digit segments. For example the credit card number 4500 6009 1945 5438 could be broken down into:
450
500
006
060
600
etc

These number sequences are loaded into a memory array as dynamic word strings and the entire text version of the audio file as created is then compared to each of these 3 digit sequences and any further occurrences of these sequences is designated for censoring without regard to any other rules. In this way the process dynamically learns about the Sensitive Data present in the audio file and ensures that all instances of such Sensitive Data are removed.

This technique is particularly useful in cases where target information is being mirrored, as between a speaker and the responder, i.e. between a client and an agent wherein the agent repeats-back portions of a client's statements in order to confirm that information has been accurately understood.

### Methods of Removing Digit Target Data

Using numerical digits as an example, there are different ways to remove digits in a speech, depending on requirements and circumstances:

1—Complete Removal: the digits will be omitted permanently. When listening back to the output recorded audio, the listener will only hear a surrogate sound that indicates there was a number omitted. There is no way to retrieve the deleted audio section.

2—Encrypted Removal: the digits will be replaced by a surrogate such as a dial tone, a beep, or any voice/sound that indicates there is a removal. This surrogate can be coded in such a way that it serves itself as an address or identifier. The original audio section cut from the audio recording will be encrypted and stored in safe place. The cut section may also be indexed against the coding contained within the surrogates. Subject to the appropriate security authorizations being provided, the cut section may then be retrieved if there is a need to check what was really said in the speech.

The edited/censored audio track is then made available for release to others as by recording it on permanent computer media such as computer disks or by transmission to a distant source.

### Special Case Situations

One example of a special case situation is an audio track which passes through the word-scrubbing engine without being modified in any respect. Such a case can be flagged for special review.

Special manual the review can be directed to affirming that there is no confidential data present in the audio track. Such a review can also identify cases where the Word scrubbing engine has failed to function successfully. This can lead to further analysis supporting modifications to the word-scrubbing engine so as to prevent future failures of a similar type.

Special review cases can also be removed from the normal employee evaluation stream to prevent further proliferation of confidential data that has escaped successful treatment by the word scrubbing engine of the invention.

### CONCLUSION

The invention is not limited to any of the described fields (such as censoring audio recordings), but generally applies to the censoring of any kind of data set.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMS. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk or a removable disk. These elements will also be found in a conventional desktop or workstation computer as well as other computers suitable for executing computer programs implementing the methods described herein.

The foregoing has constituted a description of specific embodiments showing how the invention may be applied and put into use. These embodiments are only exemplary. The invention in its broadest and more specific aspects is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

We claim:

1. A method for the preparation of a censored recording of audio data originating from a voice source in the form of either a live audio stream or a prior recording, such censored recording excluding censored portions of the original voice source comprising the steps of:
a) receiving said audio data within a volatile random access memory of a computer;
b) searching the audio data within the volatile random access memory to identify target audio data for censoring; and
c) transcribing the audio data from within the volatile random access memory to a recording medium through a filter which omits transcription of such identified target audio data,
wherein no durable or persistent version of the audio data reflecting the content of the voice source is created in the course of preparing the censored recording.

2. A method for the preparation of a censored recording of audio data originating from a voice source in the form of either a live audio stream or a recording, such censored recording excluding censored portions of the original voice source, comprising the steps of:
a) receiving the audio data into a computer having a processor which places the audio data in a first audio version volatile memory for temporary storage as either analog or digitized audio data, such stored audio data being associated with time stamped markers to provide identification for the location of portions of the audio data;
b) passing the audio data through a speech-to-text engine to produce a resulting full or partial “text” version of the audio data, wherein the audio text is identified as words including numbers or pauses which are associated with time stamped markers so as to associate such audio text with the stored audio data;
c) identifying candidate target data for censoring in the audio data, wherein the “candidate target data” may include pauses, words including numbers and fragments thereof by comparison of the audio data with a pre-established set of characteristics for target data;
d) identifying target data amongst candidate target data based upon pre-established characteristics for target data or based upon such pre-established characteristics and external context audio data in the form of validation terms that precede or follow the candidate target data;
e) identifying further target data and associated time stamped markers using elements of previously found target data as dynamic word strings, and
f) transcribing the audio data within the first volatile random access memory to a recording medium through a filter which omits transcription of such identified target audio data.

3. The method as in claim 2 wherein the audio source is an audio stream originating from a prior recording.

4. The method as in claim 2 wherein the audio source is a live audio stream.

5. The method as in claim 2 wherein candidate target data is initially identified as such based upon the presence of a pause within the audio data.

6. The method as in claim 5 wherein candidate target data is initially identified as such based upon the presence of the pause occurring adjacent to or within one word from the utterance of at least three numerals.

7. The method as in claim 6 wherein candidate target data is initially identified as such based upon the presence of the pause occurring adjacent to the utterance of four numerals.

8. The method as in claim 8 wherein candidate target data is initially identified as such based upon the presence of the pause occurring adjacent to the utterance of four numerals followed by the utterance of at least three numerals within one word from the pause.

9. The method as in claim 8 wherein candidate target data is initially identified as such based upon the presence of the pause occurring adjacent to the utterance of four numerals followed by the utterance of four numerals and another pause.

10. The method as in claim 2 wherein the validation terms are selected from the group consisting of:
a) the name of a known type of credit card,
b) the word “expiry” as a following expression,
c) the word “date” as a following word such as “expiry date”,
d) the word “account”,
e) the words “personal identification”,
f) the word “PIN”
g) the word “Card”
h) the word “Number”
i) the word “Account”
j) the word “Member”
k) the word “Telephone”
l) the word “Phone”.

11. The method as in claim 2 wherein the procedure of identifying further target data and associated time stamped markers using elements of previously found target data as dynamic word strings is repeated a second time using as a new dynamic word string based upon all or a portion of target data located by its association with the original dynamic word string.

12. The method of claim 2 wherein no durable or persistent version of audio data reflecting the original voice source is created in the course preparing the censored recording.

13. A method for the preparation of a censored recording of audio data originating from a voice source in the form of either a live audio stream or a recording, such censored recording excluding censored portions of the original voice source, comprising the steps of:
a) receiving the audio data to into a computer having a processor which places the audio data in a first audio version volatile memory for temporary storage as either analog or digitized audio data, such stored audio data being associated with time stamped markers to provide identification for the location of portions of the audio data;
b) passing the audio data through a speech-to-text engine to produce a resulting full or partial “text” version of the audio data, wherein the audio text is identified as words including numbers, or pauses which are associated with time stamped markers so as to associate such audio text with the stored audio data;
c) identifying candidate target data for censoring in the audio data, wherein the “candidate target data” may include pauses, words, numbers, and fragments thereof by comparison of the audio data with a pre-established set of characteristics for target data;
d) identifying target data amongst candidate target data based upon pre-established characteristics for target data or based upon such pre-established characteristics and external context audio data in the form of validation terms that precede or follow the candidate target data; and
e) transcribing the audio data within the first volatile random access memory to a recording medium through a filter which omits transcription of such identified target audio data,
wherein candidate target data is initially identified as such based upon the presence of a pause within the audio data.

14. The method of claim 13 wherein no durable or persistent version of audio data reflecting the original voice source is created in the course preparing the censored recording.

15. The method as in claim 13 wherein candidate target data is initially identified as such based upon the presence of a pause occurring adjacent to or within one word from the utterance of at least three numerals.

16. The method as in claim 15 wherein candidate target data is initially identified as such based upon the presence of the pause occurring adjacent to the utterance of four numerals.

17. The method as in claim 16 wherein candidate target data is initially identified as such based upon the presence of the pause occurring adjacent to the utterance of four numerals followed by the utterance of at least three numerals within one word from the pause.

18. The method as in claim 17 wherein candidate target data is initially identified as such based upon the presence of a pause occurring adjacent to the utterance of four numerals followed by the utterance of four numerals and another pause.

19. The method as in claim 13 wherein the validation terms are selected from the group consisting of:
a) the name of a known type of credit card,
b) the word “expiry” as a following expression,
c) the word “date” as a following word such as “expiry date”,
d) the word “account”,
e) the words “personal identification”,
f) the word “PIN”
g) the word “Card”
h) the word “Number”
i) the word “Account”
j) the word “Member”
k) the word “Telephone”
l) the word “Phone”.

20. A method for the preparation of a censored recording of audio data originating from a voice source in the form of either a live audio stream or a recording, such censored recording excluding censored portions of the original voice source, the censored portions comprising number target data in the form of number strings, comprising the steps of:
a) receiving the audio data containing words and number target data in the form of number strings into a computer having a processor which places the audio data into a first audio version memory for storage as either analog or digitized audio data, such stored audio data being associated with time stamped markers to provide identification for the location of portions of the audio data;
b) passing the audio data through a speech-to-text engine to produce a resulting full or partial audio “text” version of the audio data, wherein the audio text as identified includes number strings which may be of various lengths and wherein the number strings potentially erroneously contain one or more words interspersed between the numbers which words correspond to numbers in the corresponding string saved as part of the audio data in the first audio version memory, the audio text being associated with time stamped markers so as to associate such audio text with the stored audio data;
c) identifying numeric target data in the form of said number strings for censoring in the audio data by comparison of the audio data with a pre-established size for such number strings in terms of the total number of words and numbers within the string, and
d) transcribing the audio data within the first volatile random access memory to a recording medium through a filter which omits transcription of such identified numeric target data,
wherein numeric target data is identified as such based upon the length of a given number string counting an interspersed word as if such word were a number.
